(19) United States
(12) Patent Application Publication
(10) Pub. No.: US 2025/0368489 A1
(43) Pub. Date: Dec. 4, 2025

(54) ADJUSTABLE PERSONNEL STAND AND METHOD OF USE

(71) Applicant: Compass Systems & Sales, LLC, Barberton, OH (US)

(72) Inventor: Roger Edward Speece, Kirtland, OH (US)

(73) Assignee: Compass Systems & Sales, LLC, Barberton, OH (US)

(21) Appl. No.: 18/731,778

(22) Filed: Jun. 3, 2024

(51) Int. Cl. B66F 11/04

(52) U.S. Cl. CPC B66F 11/04; B66F 2700/09

(57) ABSTRACT

A personnel stand assembly should raise and lower substantially in unison across the length thereof in response to action of a lifting mechanism beneath a platform. The platform raises and lowers to position workers standing thereon at an ergonomic level for retrieval of parts or items moving along a conveyor assembly. The position of the platform can be based on the location of the item or a feature of the item. The lifting mechanism may utilize a plurality of interconnected pivot arms and tension rods, wherein the tension bars remain in tension so that the platform raises and lowers substantially in unison.

### TECHNICAL FIELD

This disclosure is directed to an adjustable personnel stand and method of use thereof.

### BACKGROUND ART

In a factory, such as an automobile factory, workers are stationed alongside conveyor belts to facilitate the assembly process of automotive parts or items. As parts move along the conveyor belts, workers execute a series of tasks to ensure their seamless integration into the manufacturing workflow. Workers are trained to swiftly retrieve parts from the conveyor belts and deposit them into designated storage areas, typically bins or racks situated on pallets adjacent to their workstations.

When parts reach their designated spot along the assembly line, workers extract parts from the conveyor belts. This process involves grasping each part securely and without disrupting the continuous flow of production. Once in hand, workers may evaluate the quality of the part, inspecting for any defects or inconsistencies that may compromise the integrity of the final product. Any deviations from the quality standards may be promptly addressed to maintain the efficiency and reliability of the assembly process.

Following assessment, workers proceed to position the parts within the designated storage areas on pallets behind them. This step requires space utilization and organization of the stored components. After arranging the parts within the bins or racks, workers facilitate ease of retrieval in subsequent stages of the assembly process.

Once a rack or bin is filled with automotive parts, the pallet carrying it may be transported to another location within the factory for further assembly or processing. This transfer is typically facilitated by material handling equipment such as forklifts or automated guided vehicles (AGVs). Workers responsible for logistics or material handling oversee the movement of pallets to ensure a seamless transition between different stages of the manufacturing process. The filled pallet is maneuvered to its designated destination based on production schedules and workflow requirements.

Upon arrival at the new location, the filled pallet is unloaded from the transport vehicle and replaced with an empty pallet carrying an empty bin or rack. This exchange allows the assembly process to continue uninterrupted, as workers can immediately begin filling the new bin or rack with parts. The empty pallet is positioned in the same location previously occupied by the filled pallet, ensuring continuity in the assembly line. This process of pallet exchange is coordinated efficiently to minimize downtime and maintain optimal productivity levels within the factory.

To facilitate the replacement of pallets, the factory may utilize automated systems or manual labor, depending on the scale of operations and technological infrastructure. Automated systems may include conveyor systems or robotic arms programmed to handle pallets and bins with precision and speed. Alternatively, manual labor may involve workers manually maneuvering pallets into position using equipment such as pallet jacks or hand trucks. Regardless of the method employed, the goal is to streamline the pallet exchange process and maintain a steady flow of parts through the assembly line, maximizing efficiency and productivity in the factory.

Some workers experience ergonomic challenges when tasked with extracting parts from a conveyor belt that can lead to various drawbacks and potential ergonomic issues. When a part is located at the far edge of the conveyor belt, workers may need to stretch and reach over the conveyor to retrieve it. This repeated stretching and reaching motion can place strain on the worker's back, shoulders, and arms, leading to discomfort or musculoskeletal injuries over time. Additionally, the awkward posture required to reach over the conveyor belt may increase the risk of accidents or mishandling of parts, potentially resulting in product defects or workplace incidents.

Similarly, when workers are required to lift parts into racks or bins positioned at heights above their shoulders, it can exacerbate ergonomic challenges. Lifting parts overhead requires significant exertion from the upper body and back muscles, particularly if the parts are heavy or the bins are positioned at a considerable height. This repetitive lifting motion can lead to strain or fatigue in the muscles and joints, increasing the risk of injuries such as strains, sprains, or even herniated discs. Furthermore, lifting parts overhead may compromise the worker's balance and stability, heightening the likelihood of slips, trips, or falls in the workplace.

### SUMMARY OF THE INVENTION

To mitigate these ergonomic drawbacks and promote worker safety and comfort, employers can implement various ergonomic interventions and adjustments. This may include redesigning workstations to minimize reaching distances or adjusting the height of conveyor belts to reduce strain on workers' backs. Providing ergonomic lifting aids such as hoists, lift-assist devices, or adjustable-height work platforms can also help alleviate the physical demands of lifting parts overhead. By addressing ergonomic concerns proactively, employers can create a safer and more comfortable work environment for workers in automotive manufacturing facilities. The present disclosure addresses these issues by providing an adjustable personnel stand that can raise and lower in unison along the length thereof so as to provide an improved position for the workers adjacent to the conveyor belt.

In one aspect, an exemplary embodiment of the present disclosure may provide a personnel stand assembly that may be installed in a factory. In one particular embodiment, the personnel stand assembly may be installed adjacent to a conveyor assembly or conveyor line that has parts or other items moving along a conveyor belt or on rollers. The personnel stand assembly is configured to be stood upon by factory workers and may be over a hundred feet long. On the other side of the personnel stand, opposite the conveyor belt, there may be racks or bins supported by pallets, wherein the racks or bins are configured to store the parts or items after those items have been picked or extracted from the conveyor assembly (e.g., from the belt or rollers) by the workers that stand on the personnel stand assembly.

In this exemplary embodiment or other exemplary embodiments, a platform surface on the personnel stand assembly is movable and adjustable between a minimum or lowered position and a maximum or raised position. The personnel stand assembly is selectively moveable to any infinite height iteration between the minimum and maximum positions. The workers stand on the platform surface at a selected height that is most ergonomic for the items or products being pulled off of the conveyor assembly (e.g., from the belt or rollers). The worker shall pick an item or part off of the conveyor assembly and places it on a rack or bin on the other side of the stand. When the rack or bin is full, a forklift carries the rack or bin (usually by engaging the pallet that supports the bins or racks), takes it away for use, and brings an empty rack or bin back so the worker can continue to fill the rack with appropriate parts.

The personnel stand assembly is advantageous, and it results in less strain on the human body of the worker because the infinitely adjustable height of the platform surface is optimized for the particular lifting or reaching needed for the project that is on the conveyor belt. For example, if the worker must reach further over the conveyor assembly (e.g., from the belt or rollers) to lift an item or product located at or near a far-edge (i.e., distally from the worker), then platform surface is raised. If the item or product is closer to a near-edge on the conveyor assembly (i.e., proximal to the worker), then the platform surface is lowered.

In one exemplary embodiment, the platform surface travels approximately six to twelve inches between the minimum or lowered position and the maximum or raised position. This vertical movement (both up and down) may be accomplished by at least one lifting mechanism. The at least one lifting mechanism may be composed of a plurality of tensioned rods or bars and at least one a pivot arm operatively coupled with at the platform surface. The tensioned bars or rods may move in response to being, directly or indirectly, driven by a motor. The tensioned bars or rods cause the pivot arm to pivot about a transverse axis to thereby cause end wheels on the pivot arm to rotate over a plate mounted on the ground that thereby imparts vertical movement (both up and down) to the platform surface. In one example, the wheel at the end of the pivot arm moves over a plate that is bolted to the ground. As the rod is pushed or pulled, it imparts movement to the pivot arm to push the wheels along the fastened plate to raise or lower the platform surface.

The rods may be maintained or kept in a state of tension, so there is no slack associated with moving the pivot arms. As the rods are moved, they cause each lift mechanism to move at the same rate. As such, the entire platform surface lifts at the same (or nearly the same) rate to the same (or nearly the same) height. In one particular embodiment, there may be less than a ±¼ inch variance across the entire platform surface.

In another aspect, an exemplary embodiment of the present disclosure may provide a personnel stand assembly comprising: a platform extending from a first end to a second end defining a longitudinal direction therebetween, the platform having a first side and a second side defining a transverse direction therebetween, and the platform having a top surface and a bottom or lower surface defining a vertical direction therebetween, wherein the top surface is adapted to support a worker standing thereon and the platform is adapted to be installed adjacent a conveyor assembly with parts moving along the conveyor assembly; a lowered position of the platform and a raised position of the platform, wherein the platform moves between the lowered position and the raised position; wherein the platform is moved to a selected height based on a part that is to be retrieved from a path of travel along the conveyor assembly.

This exemplary embodiment or another exemplary embodiment may provide that the platform is moved to a selected height based on a feature of the part that is to be retrieved form the path of travel along the conveyor assembly.

This exemplary embodiment or another exemplary embodiment may provide that the platform is moved to a selected height based on a location of the part that is to be retrieved from the path of travel along the conveyor assembly.

This exemplary embodiment or another exemplary embodiment may provide that movement of the platform occurs in response to the location of the part that is to be retrieved from the conveyor assembly, wherein parts that are located on the conveyor assembly distally from the platform cause the platform to move toward the raised position and parts on the conveyor assembly located proximal to the platform cause the platform to move toward the lowered position.

This exemplary embodiment or another exemplary embodiment may further include a lifting mechanism positioned beneath the lower surface of the platform, wherein each end of the platform raises and lowers in unison in response to movement of the lifting mechanism. This exemplary embodiment or another exemplary embodiment may further include a pivot arm having a first end and a second end defining a length of the pivot arm therebetween, wherein the length of the pivot arm is oriented in the transverse direction beneath the bottom or lower surface of the platform. This exemplary embodiment or another exemplary embodiment may further include that the pivot arm further comprises: a top and a bottom; a first pivot connection located on the top of the first end of the pivot arm, wherein a pivot axis extends through the first pivot connection, wherein the pivot axis is aligned in the transverse direction; and a second pivot connection located on the top of the second end of the pivot arm, wherein the pivot axis extends through the second pivot connection. This exemplary embodiment or another exemplary embodiment may further include that the pivot arm further comprises: a main body of the pivot arm that is positioned below the pivot axis; a first pair of flanges at the first end of the main body, wherein the first pivot connection is defined between the first pair of flanges; and a second pair of flanges at the second end of the main body, wherein the second pivot connection is defined between the second pair of flanges. This exemplary embodiment or another exemplary embodiment may further include a first wheel located on the bottom near the first end of the pivot arm; and a second wheel located on the bottom near the second end of the pivot arm. This exemplary embodiment or another exemplary embodiment may further include at least one tension bar that has a first end connected to the first pivot arm and a second end connected to the second pivot arm, wherein the at least one tension bar is in a state of tension during operation of the lifting mechanism to move the platform between the lowered position and the raised position. This exemplary embodiment or another exemplary embodiment may further provide that the state of tension in the at least one tension bar varies by less than 5% during movement of the platform between the lowered position and the raised position, which can assist in raising or lowering the total length of the platform at a uniform or substantially uniform rate (i.e., in unison or near-unison). This exemplary embodiment or another exemplary embodiment may further provide that the state of tension in the at least one tension bar is constant. This exemplary embodiment or another exemplary embodiment may further provide that linear translation of the at least tension bar in the longitudinal direction imparts rotational movement to the first pivot arm and the second pivot arm.

This exemplary embodiment or another exemplary embodiment may further include a control unit that executes instructions stored in at least one non-transitory computer readable storage medium, wherein the instructions include an instruction to automatically raise or lower the platform based on the part that is to be retrieved form a path of travel along the conveyor assembly.

In yet another aspect, an exemplary embodiment of the present disclosure may provide a method comprising: having a personnel stand assembly installed adjacent to a conveyor assembly, wherein the personnel stand assembly comprises a platform extending from a first end to a second end defining a longitudinal direction therebetween, the platform having a first side and a second side defining a transverse direction therebetween, and the platform having a top surface and a bottom or lower surface defining a vertical direction therebetween; moving the platform between a lowered position and a raised position of the platform, wherein the platform is moved to a selected height based on a part that is to be retrieved from a path of travel along the conveyor assembly; and effecting a worker to stand upon the platform at the selected height and retrieve the part from the conveyor assembly. This exemplary embodiment or another exemplary embodiment may further provide that the selected height of the platform is based on a location of the part on the conveyor assembly. This exemplary embodiment or another exemplary embodiment may further include raising the platform upward in response to the part being located near a distal edge of the conveyor assembly. This exemplary embodiment or another exemplary embodiment may further include lowering the platform downward in response to the part being located near a proximal edge of the conveyor assembly. This exemplary embodiment or another exemplary embodiment may further provide that moving the platform between a lowered position and a raised position of the platform is accomplished by a lifting mechanism positioned beneath the lower surface of the platform, and the lifting mechanism comprises at least one pivot arm in operation communication with a tension bar that is coupled to a motor that linearly translates the tension bar. Each end of the platform may raise and lower in unison in response to movement of the lifting mechanism.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top first end perspective view of two personnel stand assemblies installed adjacent to a conveyor assembly according to one aspect of the present disclosure.

FIG. 2 is a diagrammatic top plan view of the two personnel stand assemblies.

FIG. 2A is an enlarged diagrammatic top plan view of one side of one personnel stand assembly shown with the platform removed to expose the lifting mechanism.

FIG. 3 is a perspective view of one platform segment located in the region labeled as “See FIG. 3,4” in FIG. 2A.

FIG. 4 is a perspective view of a frame of one platform segment shown with the panels removed and located in the region labeled as “See FIG. 3,4” in FIG. 2A.

FIG. 5 is a perspective view of two pivot arms located in the region labeled as “See FIG. 5” in FIG. 2A.

FIG. 5A is an exploded perspective view of a first pivot arm.

FIG. 5B is an exploded perspective view of a second pivot arm.

FIG. 6A is a perspective view of a first lower plate that is located in the region labeled as “See FIG. 6A” in FIG. 2A.

FIG. 6B is a perspective view of a first lower plate that is located in the region labeled as “See FIG. 6B” in FIG. 2A.

FIG. 7A is an assembled perspective view of the first pivot arm and the first lower plate that is located in the region labeled as “See FIG. 7A” in FIG. 2A.

FIG. 7B is an assembled perspective view of the first pivot arm and the first lower plate that is located in the region labeled as “See FIG. 7B” in FIG. 2A.

FIG. 7C is an assembled perspective view of another second pivot arm and another second lower plate that is located in the region labeled as “See FIG. 7C” in FIG. 2A.

FIG. 7D is an assembled perspective view of another first pivot arm and another first lower plate that is located in the region labeled as “See FIG. 7D” in FIG. 2A.

FIG. 7E is an assembled perspective view of another first pivot arm and another first lower plate that is located in the region labeled as “See FIG. 7E” in FIG. 2A.

FIG. 8 is a top perspective view of the motor that is located in the region labeled as “See FIG. 8” in FIG. 2A.

FIG. 9A is a longitudinal cross section view of the motor and stand assembly, shown as being exploded from the ground, which is located in the region labeled as “See FIG. 9A, 9B, 9C” in FIG. 2A.

FIG. 9B is a longitudinal cross section view of the motor and stand assembly, shown installed in the ground, which is located in the region labeled as “See FIG. 9A, 9B, 9C” in FIG. 2A.

FIG. 9C is a longitudinal cross section view of the motor and stand assembly, shown installed in the ground and the platform in the raised position, which is located in the region labeled as “See FIG. 9A, 9B, 9C” in FIG. 2A.

FIG. 10A is a diagrammatic side elevation view of the stand assembly shown in the lowered position.

FIG. 10B is a diagrammatic side elevation view of the stand assembly shown in the raised position.

FIG. 11A is a diagrammatic end elevation view of a worker on the stand assembly that is lifting an item from a proximal edge of the conveyor assembly with the stand assembly in the lowered position to encourage proper ergonomics.

FIG. 11B is a diagrammatic end elevation view of a worker on the stand assembly that is lifting an item from a distal edge of the conveyor assembly with the stand assembly in the lowered position that results in improper ergonomics.

FIG. 11C is a diagrammatic end elevation view of a worker on the stand assembly that is lifting an item from a distal edge of the conveyor assembly with the stand assembly in the raised position to encourage proper ergonomics.

Similar numbers refer to similar parts throughout the drawings.

### DETAILED DESCRIPTION

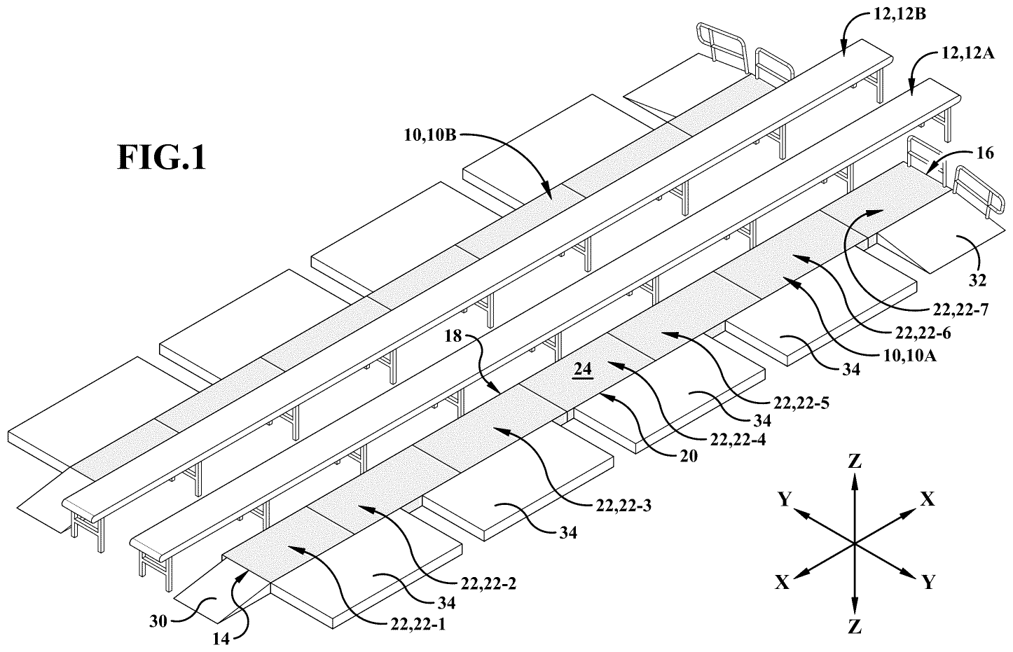

The figures depict a personnel stand assembly generally at 10. The stand assembly 10 permits a worker to stand thereon. At least a portion of the stand assembly 10 is to be installed adjacent a conveyor assembly 12 with parts moving along the conveyor assembly 12. Typically, the conveyor assembly 12 is located within a factory or other manufacturing facility. In some implementations, there are two stand assemblies 10, with each respective stand assembly being installed on opposite sides of the conveyor assembly 12. For example, FIG. 1 depicts a first stand assembly 10A on a first side of a first conveyor assembly 12A and a second stand assembly 10B on a second side of a second conveyor assembly 12B. It is to be understood that each respective stand assembly 10A, 10B are mirrored identical to each other. As such, reference will be made to only one of the stand assemblies herein, yet it is to be understood that the components, features, and functions are duplicated on the other stand assembly but for brevity are not described twice.

The stand assembly 10 includes a first end 14 and a second end 16 defining a longitudinal direction X therebetween. The stand assembly 10 includes a first side 18 and a second side 20 defining a transverse direction Y therebetween. The longitudinal direction X is perpendicular to the transverse direction Y. A vertical direction Z extends orthogonal to the longitudinal direction X and the transverse direction Y, similar to conventional cartesian coordinates.

The stand assembly 10 includes a platform 22 extending from or near the first end 14 to or near the second end 16. The platform 22 has a top surface 24 and a bottom or lower surface with the vertical direction Z extending therebetween. The top surface 24 shall support a worker standing thereon when the platform 22 is installed adjacent to the conveyor assembly 12 with parts moving along the conveyor assembly 12.

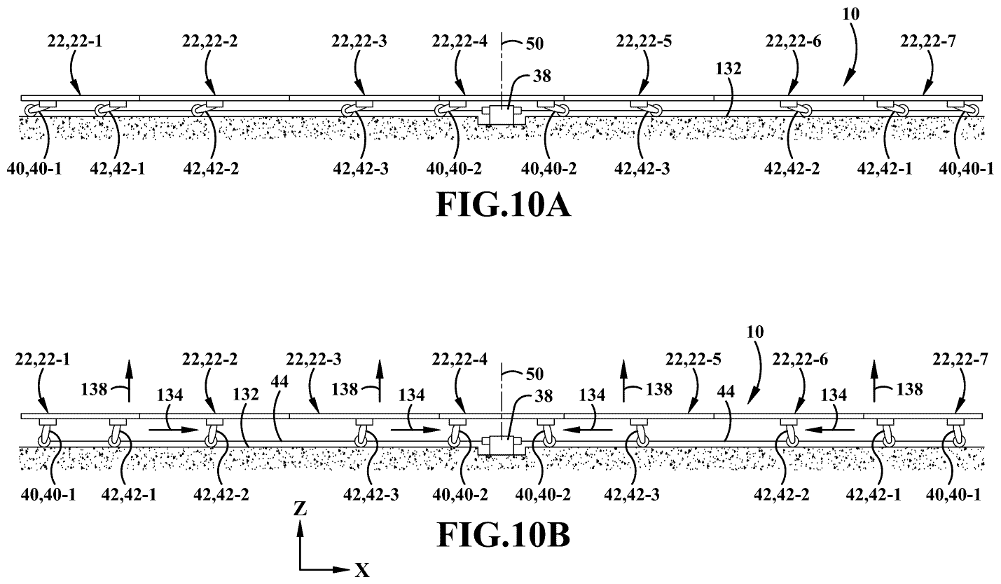

The platform 22 is moveable between a minimum or lowered position (as shown in FIG. 10A) and a maximum or raised position (as shown in FIG. 10B). The platform is repeatedly moveable between the lowered position and the raised position. In some exemplary embodiments, the amount of travel between the lowered position and the raised position is in a range from about six inches to about twelve inches. In one particular embodiment, the amount of travel in the vertical direction Z between the lowered position and the raised position is about eight inches.

In one particular embodiment of the present disclosure, movement of the platform 22 occurs in response to the location of a part that is to be retrieved from the conveyor assembly 12. In this example, distally located parts (i.e., parts located farther from the worker) on the conveyor assembly 12 cause the platform 22 to move toward the raised position and proximally located parts (i.e., parts located closer to the worker) on the conveyor assembly 12 cause the platform 22 to move toward the lowered position.

Although this particular embodiment identifies that the movement of the platform is related to the location of the parts moving along the conveyor assembly 12, other embodiments of the present disclosure can cause the movement of the platform based on other variables. For example, movement of the platform can occur in response to the size or height of the workers on the platform, or in response to the speed at which one or more objects travel along then conveyor assembly 12, or combinations thereof.

As detailed herein, the stand assembly 10 includes a lifting mechanism 26. The lifting mechanism 26 includes a variety of components that cooperate together to raise and lower the platform 22. In one embodiment, the lifting mechanism 26 is positioned beneath the lower surface of the platform 22, wherein each end of the platform 22 raises and lowers in unison in response to movement of the lifting mechanism 26. In one particular embodiment, the entirety of the top surface 24 of the platform 22 raises and lowers in unison in response to movement of the lifting mechanism 26. In another exemplary embodiment, the platform surface 24 lifts at nearly the same rate to nearly the same height such that there is less than a ±¼ inch variance in the vertical direction Z across the entire length of the platform surface 24, which may be over one hundred feet long. The features and components of the lifting mechanism are explained in greater detail herein.

FIG. 1 further depicts that the stand assembly 10 can additionally include a first ramp 30 located at or near the first end 14. Additionally, there may be a second ramp 32 located at or near the second end 16. Each of the ramps permit ingress and egress for a worker onto the top surface 24 of platform 22. In the shown embodiment, the first ramp 30 is inclined relative to the longitudinal direction X and the second ramp 32 is inclined relative to the transverse direction Y. It is to be understood that these orientations of the ramps are merely exemplary and both ramps could be inclined relative to the longitudinal direction X or both ramps could be inclined relative to the transverse direction Y.

With continued reference to FIG. 1, along the first side 18 of the stand assembly 10 is positioned the conveyor 12. Opposite the conveyor 12 and adjacent to the second side 20, there may be one or more racks or stands 34. The rack 34 is shown diagrammatically and could be embodied as a pallet stand that is configured to receive parts being pulled from the conveyor assembly 12 by the worker. When the rack 34 or stand is full of parts having been pulled from the conveyor assembly 12, a forklift operator or another autonomous robot could be utilized to remove the stand and move it to another location in the factory, replacing that space with an empty rack or stand for subsequent filling of parts.

FIG. 1 further depicts that the platform 22 can be formed from a plurality of platform segments 22-1, 22-2, 22-3, 22-4, 22-5, 22-6, and 22-7. Although it is shown that there are seven platform segments 22-1 through 22-7, it is to be understood that the number of platform segments can be any number defining the overall platform 22. Each of these platform segments 22-1 through 22-7 are connected end-to-end to collectively form the overall top surface 24 of the platform 22. Each respective platform segment has its own first end and second end aligned such that the platform segments extend longitudinally in the longitudinal direction X, and each platform segment includes its own first side and second side aligned in the transverse direction to collectively define the first side 18 and the second side 20 of the stand assembly 10. Each platform segment may have its own frame 54, which is detailed further herein.

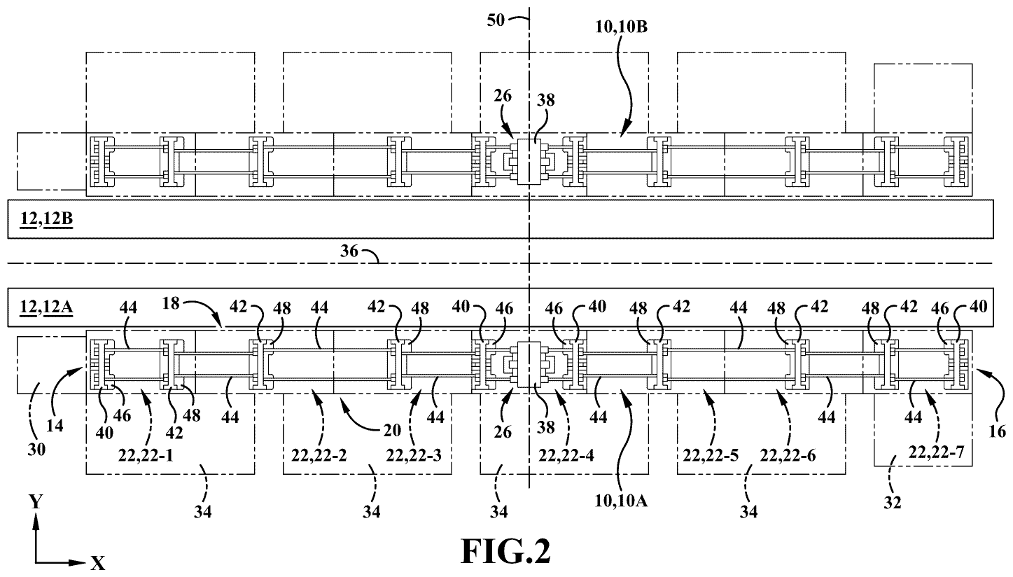

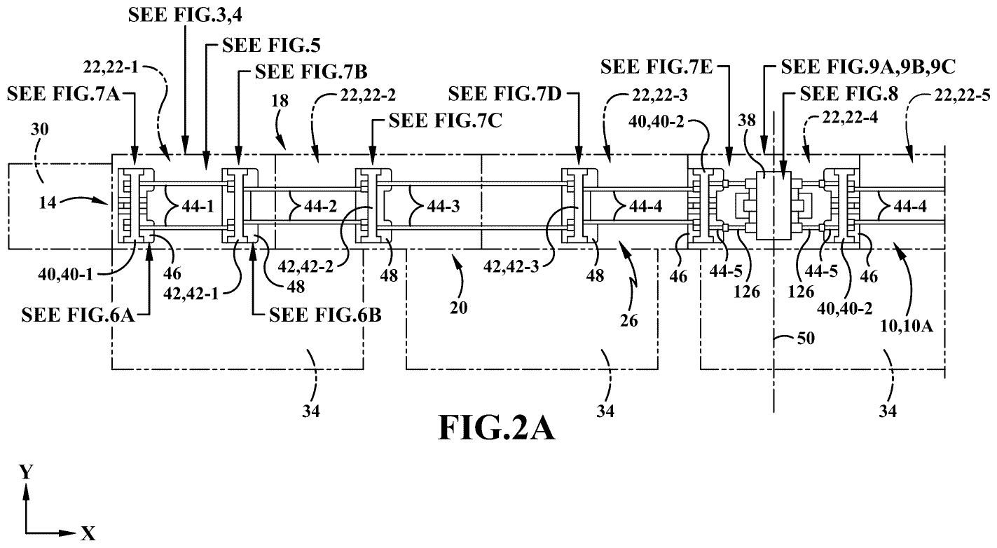

FIG. 2 is a diagrammatic top plan view of the first stand assembly 10A and the second stand assembly 10B with the top surface 24 of each platform 22 being removed such that the lifting mechanism 26 is exposed for descriptive purposes. As discussed previously, the first stand assembly 10A and the second stand assembly 10B are mirrored oppositive of each other relative to the longitudinal axis 36. Thus, reference will be made to one of the stand assemblies 10, such as first stand assembly 10A, and it is to be understood that the second stand assembly 10B has a similar structural configuration mirrored about the longitudinal axis 36.

The lifting assembly, which may be generally referred to as the lifting mechanism 26, is located below the bottom or lower surface of the platform 22. The lifting mechanism 26 may include a variety of components that effectuate the movement of the platform top surface 24 in unison along the longitudinal length thereof. The lifting mechanism 26 may include a motor 38, at least one first pivot arm 40, at least one second pivot arm 42, one or more tension bars or tension rods 44, a first lower frame plate 46 and a second lower frame plate 48. The lifting mechanism 26 may be symmetric relative to a transverse axis 50 such that the components of the lifting mechanism 26 that are offset from the axis 50 toward the first end 14 are the same as the components of the lifting mechanism 26 that are offset toward the second end 16 on the opposite side of transverse axis 50. As such, reference will be made to those components between the first end 14 and the transverse axis 50, however it is to be understood that similar components are located between the second end 16 and the transverse axis 50 and collectively they define the lifting mechanism 26.

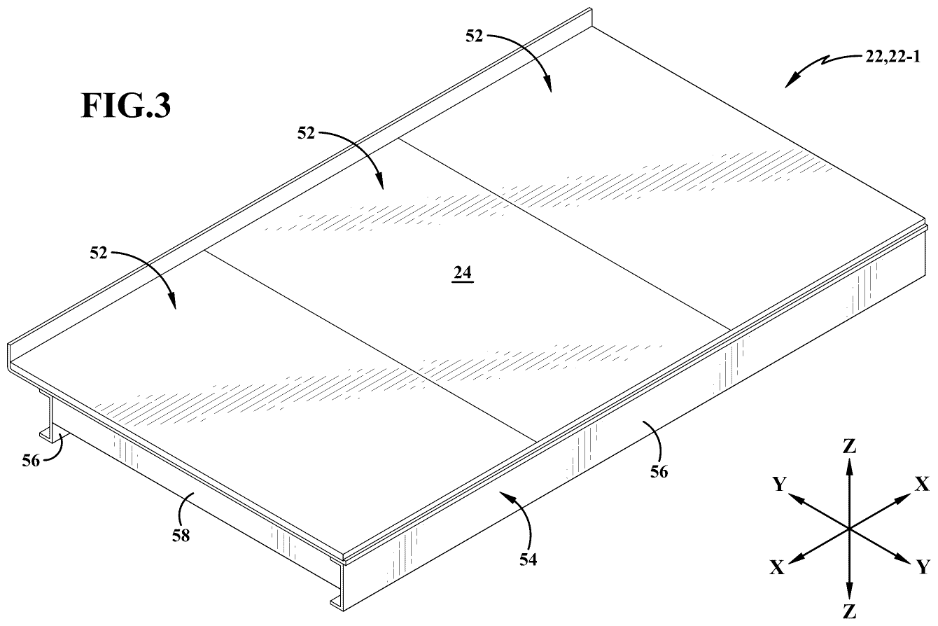

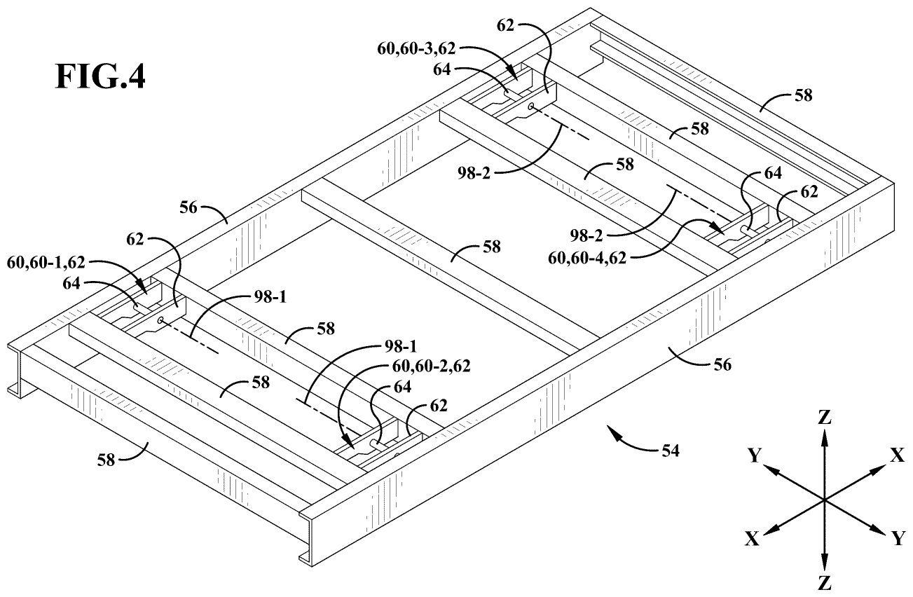

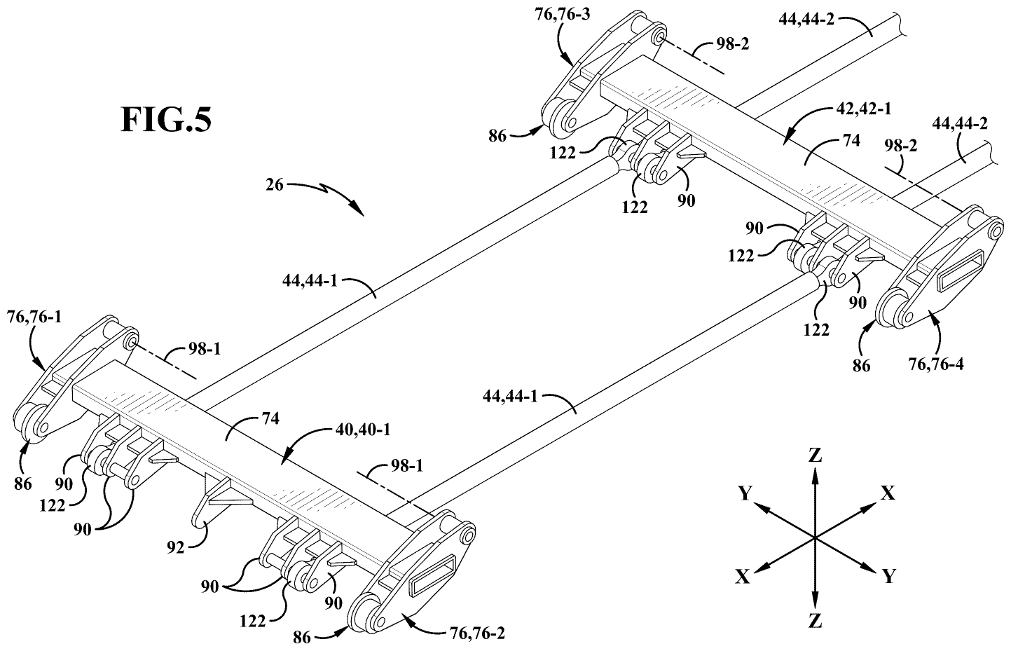

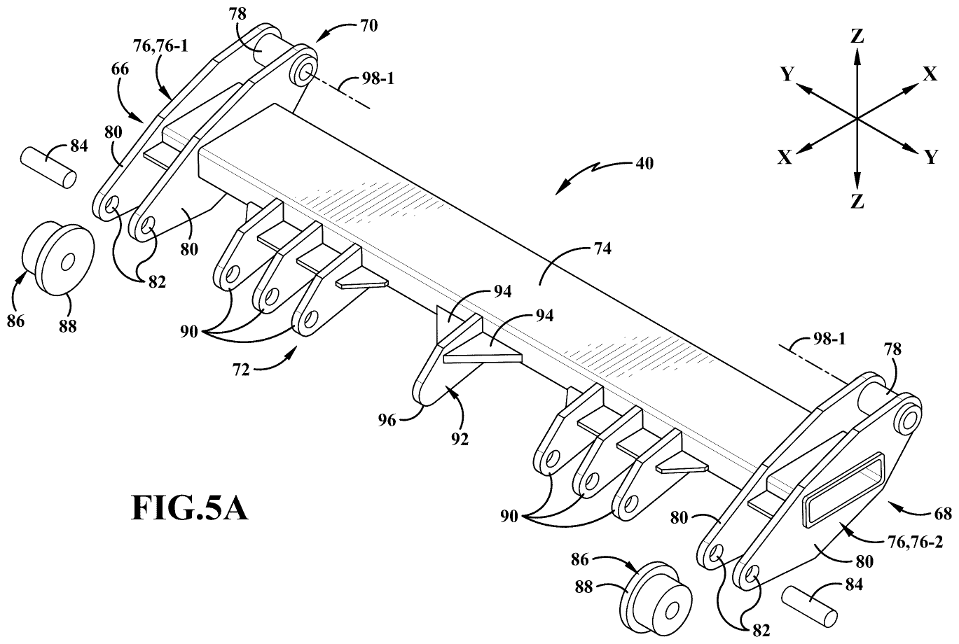

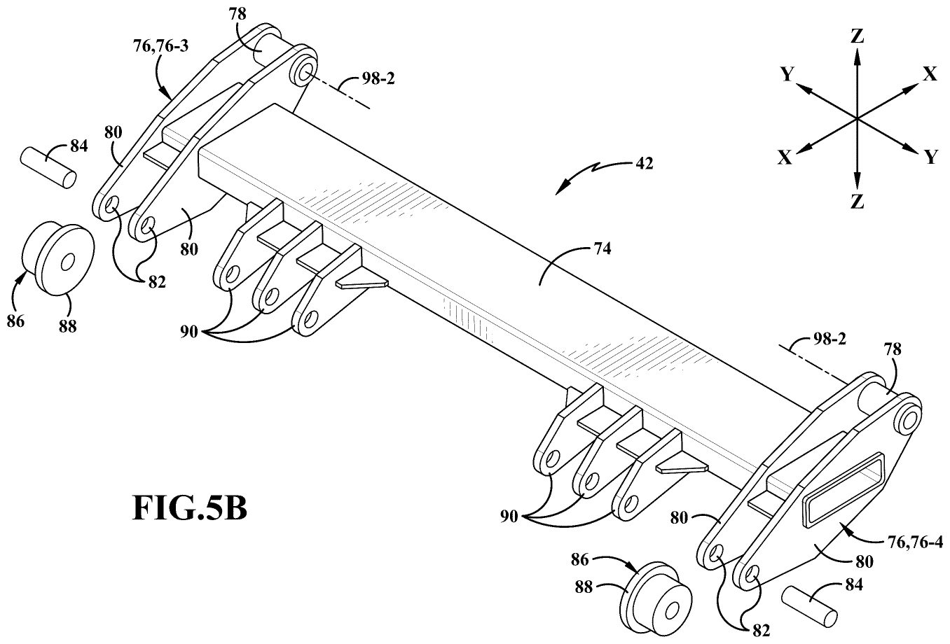

FIG. 2A is an enlarged diagrammatic view of the lifting mechanism 26 of the first stand assembly 10A detailing the components of the lifting mechanism 26 that are located between the first end 14 and the transverse axis 50. Additionally, reference to other figures that provide greater detail to the lifting mechanism 26 are identified with lead lines and regions identified with corresponding figure designators. For example, FIG. 3 and FIG. 4 are enlarged views of the region identified as “See FIG. 3, 4” in FIG. 2A. FIG. 5 is an enlarged view of the region identified as “See FIG. 5” in FIG. 2A. The other figures are enlarged views that correspond to the remaining regions so labeled in FIG. 2A.

FIG. 2A depicts that there are a plurality of first pivot arms 40 and a plurality of second pivot arms 42 that are linked together via tension arms or tension bars 44 between the transverse axis 50 and the first end 14 of the lifting mechanism 26. The respective plurality of first pivot arms 40 and second pivot arms 42 may be followed by a numeral designator that refers to that specific pivot arms. For example, one of the first pivot arms is designated as 40-1 and another of the first pivot arms is designated as 40-2. One of the second pivot arms is designated as 41-2 and another one of the second pivot arms is designated as 42-2, and another is designated as 42-3, and so on.

FIG. 3 and FIG. 4 depict one of the platform segments, namely the first platform segment 22-1. The platform segment 22-1, as well as the other platform segments 22, may include one or more panels 52 that are generally rectangular or square in shape and formed as planar members that rest atop a frame 54 to collectively define the platform top surface 24. The panels 52 may be coated with a non-slip material, if desired. Alternatively, to improve ergonomics for the worker standing upon the panels, there could be a cushion applied to the panel that the worker stands upon. Further, the panels need not be solid planar members as shown. For example, the panels 52 could be defined by grating.

The frame 54 includes opposing longitudinal beams 56 and transverse beams 58. The beams 56 and 58 should be sufficiently strong to support the panels 52 thereon and a worker standing upon the top platform surface 24. The exact structural configuration of the beams 56 and 58 could take any form factor sufficient to support the platform 22 without disturbing the operation of the lifting mechanism 26. The frame 54 may additionally include a bracket 60 located between two adjacent transverse beams 58. The bracket 60 may be defined by two longitudinally extending plates 62 and a transversely extending pin 64. The pin 64 may define a pivot axis 98 for one of the pivot arms that will be connected to the frame 54.

In one particular configuration, each platform segment 22 includes four brackets 60. Namely, a first bracket 60-1, a second bracket 60-2, a third bracket 60-3, and a fourth bracket 60-4, where each of these brackets 60 are configured identical to each other but located at different portions of the frame 54. The first bracket 60-1 is located near the first side and the first end of the frame 54. The second bracket 60-2 is located near the second side and the first end of frame 54. The third bracket 60-3 is located along the first side near the second end of frame 54. The fourth bracket 60-4 is located along the second side and near the second end of frame 54. The pin 64 of the first bracket 60-1 is aligned with the pin 64 on the second bracket 60-2 to collectively define a transverse pivot axis 98-1 extending therethrough. The pin 64 on the third bracket 60-3 is transversely aligned with the pin 64 on the fourth bracket 60-4 to define a second pivot axis 98-2 extending transversely across the frame 54. As will be described in greater detail below, these pins receive or couple with a cylindrical coupling on each respective pivot arm.

FIG. 5, FIG. 5A, and FIG. 5B depict the configuration and assembly of the first pivot arm 40 and the second pivot arm 42. The first pivot arm 40 includes a first end 66 and second end 68, wherein the length of the first pivot arm 40 extends between the first end 66 and the second end 68 and is oriented in the transverse direction Y. The first pivot arm 40 includes a top or upper end 70 and a bottom or lower end 72. The pivot arm 40 includes a rectangular body or rectangular member 74 that extends in the transverse direction between the first end 66 and the second end 68. There is a first bracket 76-1 located at or near the first end 66 of the rectangular body 74 and there is a second bracket 76-2 located at the second end 68 of the rectangular body 74. Each bracket 76 is identical to the other bracket but located on opposing ends of the rectangular body 74. At the upper end of the first bracket 76-1 there is a cylinder 78 that extends between two plates 80 of the bracket 76. The lower end of the plates defines apertures 82 that receive pin 84 therethrough to attach a wheel 86. Each wheel 86 may include a flange 88 that has a larger diameter than the central portion of the wheel 86. The rectangular body 74 may additionally include flanges 90 that are used to mount the tension bar or tension rods 44 to the rectangular body 74 of the first pivot arm 40. The flanges 90 extend in a cantilevered manner downwardly from the rectangular body 74 and may include transversely-aligned apertures therethrough to retain mounting pins to establish a pivoting connection with one end of the one of the tension rods 44.

Each plate 80 may be elongated in the longitudinal direction X having a rounded upper end near the cylinder 78 and a rounded lower end near the aperture 82. There may be straight wall sections extending between the rounded ends. The plate 80 may be welded to the exterior surface of the rectangular body 74 such that the rectangular body 74 extends through each respective plate 80. The plate 80 may be an elongated hexagonal plate that offsets the cylinder 78 above the rectangular member 74 and the wheel 86 below the rectangular member 74. As such, the rectangular member 74 may extend transversely through each respective plate 80 near the center thereof.

The first pivot arm 40 differs from the second pivot arm 42 inasmuch as it includes a central guide flange 92 that extends in a cantilevered manner downwardly from the lower portion of the rectangular body 74. The guide flange may be centered directly, relative to the transverse axis, between the first end 66 and the second 68 of the rectangular member 74. The guide flange 92 is a plate that has a terminal end 96. The flange 92 may be supported with one or more gussets 94. The guide flange 92 is configured to slide within a corresponding slot or channel formed in the first lower frame plate 46, which will be described in greater detail herein.

FIG. 5B depicts that the second pivot arm 42 is shaped largely similar to that of the first pivot arm 40. However, one distinction is that the second pivot arm 42 does not include the guide flange 92, or its supporting gussets 94. As such, for brevity, the reference numerals are repeated from FIG. 5A where similar reference numbers correspond to similar structural configurations. Yet, it can be seen that the second pivot arm has no center guide flange.

With continued reference to FIG. 5B, the similar reference numerals are shown similar to that of first pivot arm 40, except the brackets are shown as third bracket 76-3 and fourth bracket 76-4 that correspondingly couple with the respective brackets 60 on the frame 54 to which each respective bracket is mounted. For example, as will be described in greater detail herein, bracket 76-1 on the first pivot arm 40 mounts to the bracket 60-1 on the frame 54. The bracket 76-2 mounts to the bracket 60-2 on the frame 54. The bracket 76-3 on the second pivot arm 42 mounts to the bracket 60-3 on the frame 54. The bracket 76-4 on the second pivot arm 42 mounts to the bracket 60-4 on frame 54. The manner in which each of these respective brackets 60 mounts to the brackets 76 is by the pin 64 on each bracket 60 extending through a corresponding cylinder 78 on each respective bracket 76. This establishes a pivoting relationship such that the pivot arm 40 pivots about a transverse pivot axis 98-1. Similarly, the second pivot arm 42 is connected with brackets 60-3 and 60-4 to pivot about the second pivot axis 98-2.

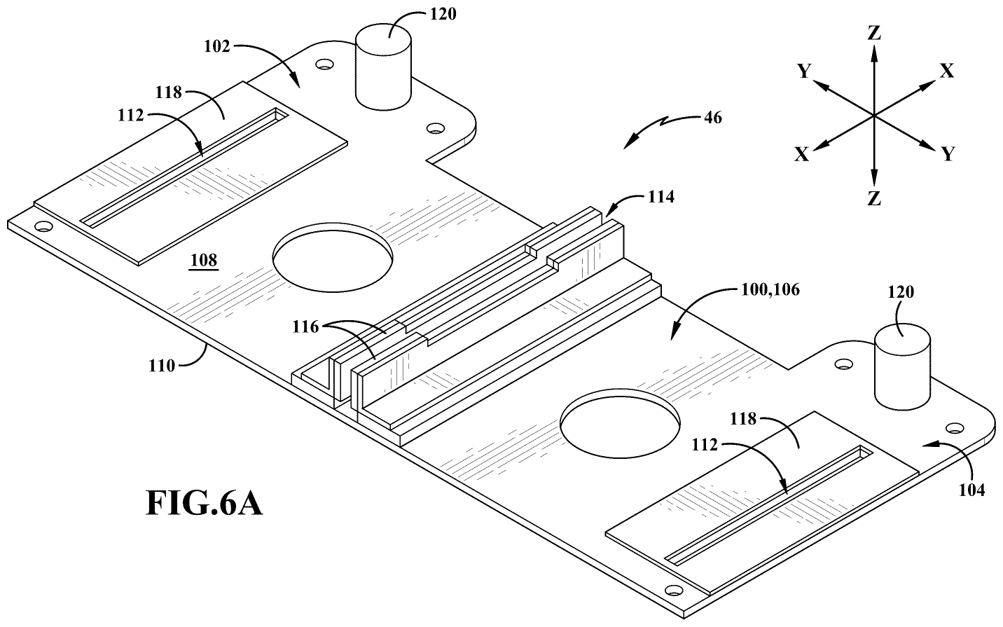

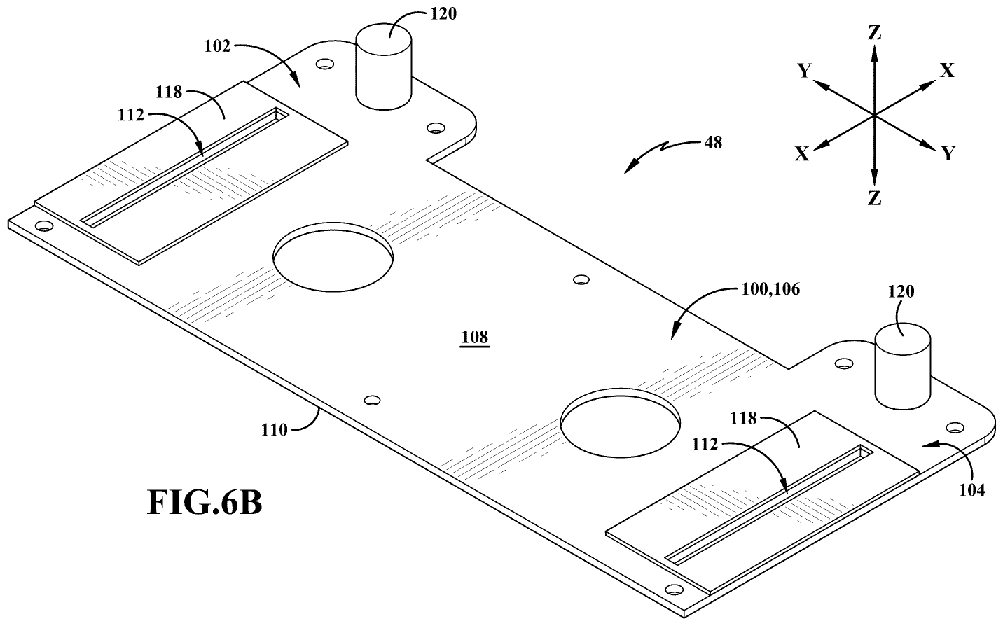

FIG. 6A and FIG. 6B depict the first lower plate 46 and the second lower plate 48, respectively. Each frame plate will be mounted on the floor or ground of the factory and allows the pivot arms to traverse there above. Many of the features of the two plates are similar and are not repeated for brevity. The plates are shaped and configured to interact with the corresponding pivot arm. Particularly, the first lower plate frame 46 interacts and cooperates with the first pivot arm 40 and the second lower frame plate 48 interacts with the second pivot arm 42.

Each lower frame plate is a generally rigid U-shaped plate having a body 100 comprising a first leg 102, a second leg 104, and a central leg 106. The body of the U-shaped plate defines an upwardly facing top surface 108 and a downwardly facing bottom surface 110 wherein the thickness of the body 100 of the U-shaped plate is defined between the top surface 108 and the bottom surface 110. The perimeter of the first lower frame plate 46 is defined by the outer edges of each of the respective legs 102, 104 and 106. On the first leg 102 there is a wheel channel 112 that is configured to receive one of the flanges 88 on the wheel 86 that is connected to the first bracket 76-1 on the first pivot arm 40. Similarly, a channel 112 may be formed in the second leg 104 of the body 100 that extends in the longitudinal direction X that is configured to receive the flange 88 on the wheel 86 connected to the second bracket 76-2 on the first pivot arm 40. A central guide channel 114 is defined between two L-shaped members 116 that extend in the longitudinal direction X across the top surface 108 of the body 100 of the U-shaped plate. The guide channel 114 is configured to receive the guide flange 92 on the first pivot arm 40. The guide flange 92 slides within the guide channel 94 as the wheels 86 on the first pivot arm 40 rotate. The flange 88 on each respective wheel 86 slides within the wheel channels 112 to ensure that the wheels properly move in the longitudinal direction X and do not deviate in the transverse direction Y. As such, the flange 88 fits down within the wheel channel 112 and the cylindrical primary portion of the wheel 86 rolls along the wheel plate 118 placed atop the top surface 108 of the body 100. Each respective wheel plate 118 may have a slot formed therethrough in the vertical direction Z to provide access to the channel 112 for the flange 88 of wheel 86.

FIG. 6B depicts that the second lower frame plate 48 is similar to the first lower frame plate 46 except that plate 48 eliminates the two L-shaped members 116 that define the guide channel 114. This is because the second lower plate frame 48 cooperates with the second pivot arm 42 which does not have any central guide flange. As such, there is no need for the central guide channel 114 to be defined on the second lower frame plate 48. However, it is to be understood that the interaction of the wheels 86 on the second pivot arm 42 still insert the flanges 88 into the channels 112 and the remainder of the wheel 86 rotates atop the wheel plate 118. Notably however is that an alternative embodiment of the present disclosure could provide plate 46 to be used with the second pivot arm 42 since the second pivot arm 42 does not include any central guide flange, the central guide channel 114 would simply be unused and passed over during the pivoting action of the pivot arm 42.

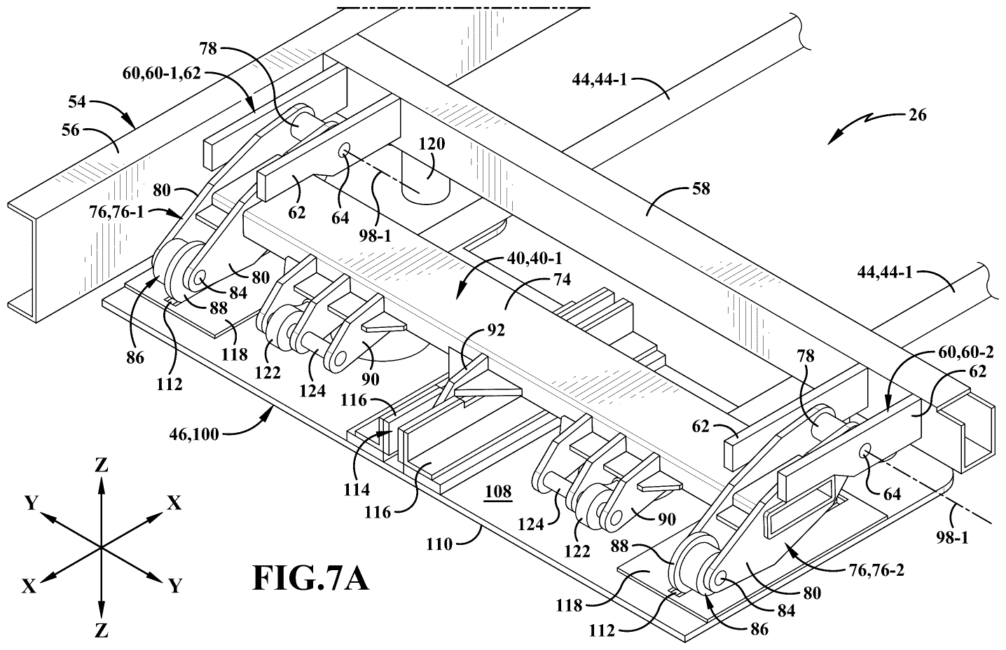

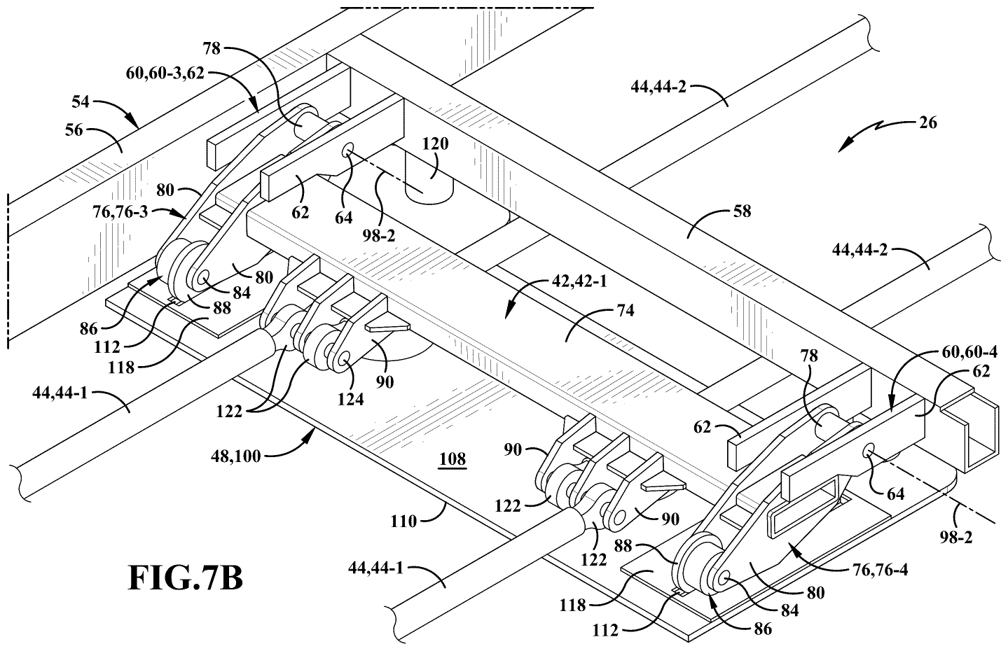

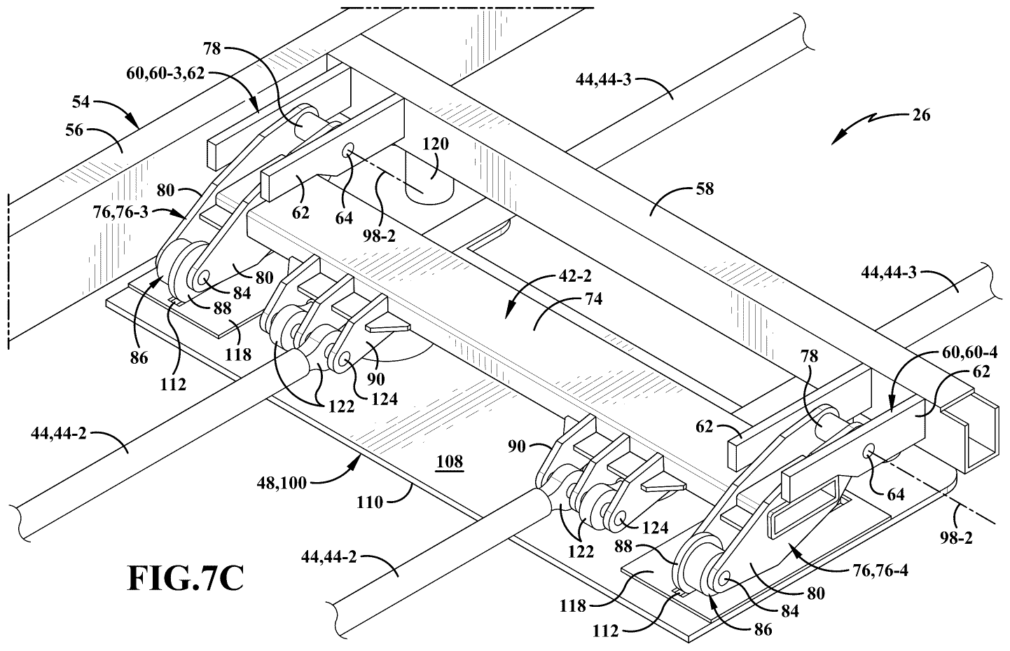

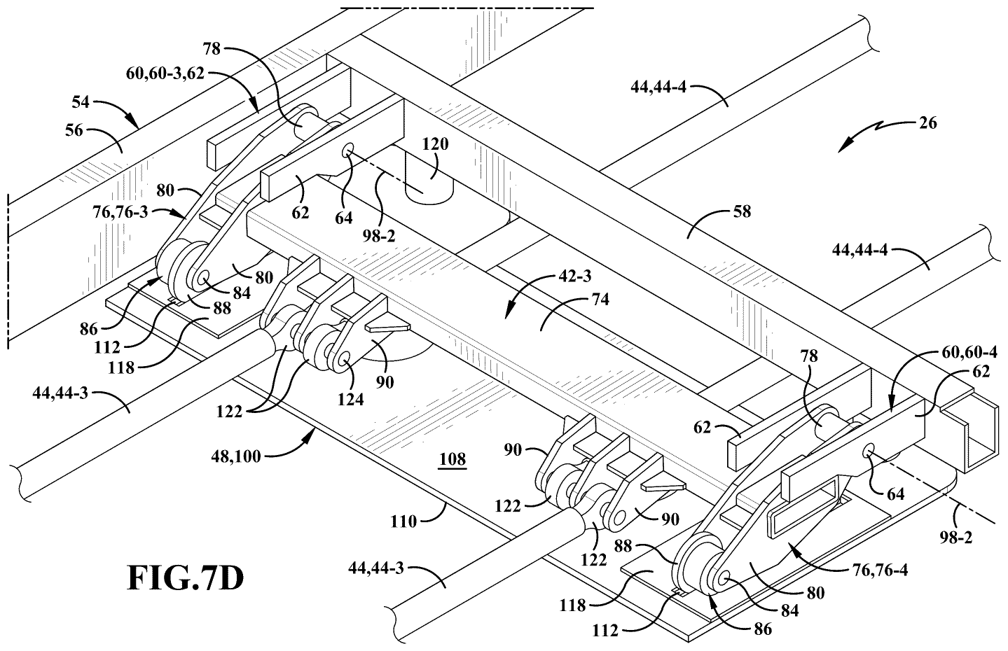

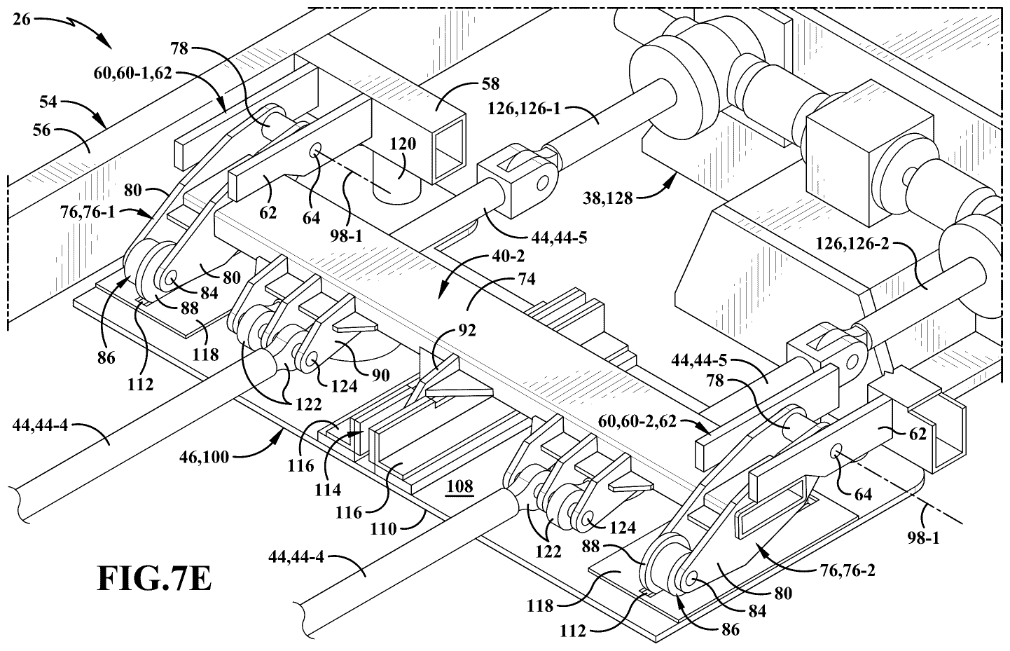

FIG. 7A depicts the assembled configuration of the first lower frame plate 46 and the first pivot arm 40. Lower frame plate 46 may include a support block 120 that extends upwardly through from the upper surface 108 of the body 100. The support block 120 is positioned below one of the transverse beams 58 of the frame 54 to support the frame thereon. The pin 64 on the first bracket 60-1 is inserted through the transversely extending bore of the cylinder 78 on bracket 76-1. Similarly, pin 64 on the second bracket 60-2 is inserted through the cylinder 78 on bracket 76-2. Collectively, the pins 64 define the first pivot axis 98-1 that will allow the first pivot arm 40 to rotate. The plates 80 of the brackets 76 are positioned between the plates 62 of the brackets 60. The wheels 86 have the flange 88 inserted into the wheel channel 112 and the remainder of the cylindrical body of the wheel 86 rests atop the wheel plate 118. The guide flange 92 is inserted into the guide channel 114. As will be shown below, as the tension rod 44 pulls the pivot arm 40 in the longitudinal direction X, tension on the tension rod 44 will cause the pivot arm 40 to move in the longitudinal direction as it pivots about the first pivot axis 98-1. The pivoting of the pivot arm 40 about the pivot axis 98-1 will cause the wheels to rotate with their flanges 88 within the channel 112. This will also cause the guide flange 92 to slide within the guide channel 114. The end 122 of the tension rod 44 is pivotally connected via a pin 124 with the flanges 90 on the rectangular member 74. This establishes another pivot axis for the first pivot arm 40.

FIG. 7B depicts that the configuration of the second pivot arm 42 with the second lower frame plate 48 is largely similar to that which was described with respect to FIG. 7A except there is no central guide flange or guide channel. It can be seen that the wheels 86 have their respective flanges 88 that are nested into the wheel channels 112 with the remainder of the cylindrical portion of the wheel 86 atop the wheel plate 118.

FIG. 7C, FIG. 7D, and FIG. 7E depict the other pivot arms located between the first end 14 and transverse axis 50. For example, FIG. 7C and FIG. 7D each depict another second pivot arm 42 that is located between the first end 14 and the transverse axis 50. The additional second pivot depicted in FIG. 7C is depicted as 42-2. The additional second pivot arm depicted in FIG. 7D is depicted as 42-3. Thus, there are three second pivot arms 42 located between the first pivot arm 40 and another first pivot arm 40-2 that is coupled with the motor 38. Stated otherwise, the first pivot arm 40-1 is located most distal from the motor 38 relative to transverse axis 50. The second pivot arm 42-1 is located proximately from the first pivot arm 40. Another second pivot arm 42-2 is located proximately from second pivot arm 42. Another second pivot arm 42-3 is located proximately from pivot arm 42-2. Another first pivot arm 40-2 is located proximately from the second pivot arm 42-3. The terms proximal and distal in this particular instance are measured and referred to in the longitudinal direction relative to the transverse axis 50. Each of these pivot arms are linked together via tension rods 44 that are connected end-to-end at respective flanges 90 on each of the pivot arms.

FIG. 7E depicts the other first pivot arm 40-2 being connected with another first lower flame plate 46 adjacent the motor 38. A motor linear drive arm 126 extends outward from the motor 38 in the longitudinal direction X and couples with a tension rod 44. The end 122 of the tension rod 44 shown in FIG. 7E is coupled with one of the flanges 90 on the other first pivot arm 40-2. The motor linear drive arm 126 moves linearly in the longitudinal direction X. Movement of the motor linear drive arm 126 and its coupling linkage to the tension rod 44 imparts movement to the other first pivot arm 40-2. The flanges 90 on the other first pivot arm 40-2 are connected with other tension bars, which may be referred to as 44-4. The tension of pulling the tension rod 44-5 by the motor linear drive arm 126 imparts tension into the tension rod 44-4 that is connected to pivot arm 40- 2. The ends of the tension rods 44-4 are connected with the pivot arm 42-3. At bracket 90 of pivot arm 42-3, the ends of tension bars 44-3 are connected. The other ends of the tension bars 44-3 are connected to the brackets 90 on the pivot arm 42-2. The ends of the tension bars 44-2 are connected to the brackets 90 on pivot arm 42-2. The other end of the tension bars 44-2 are connected to the brackets 90 on the pivot arm 42 (see FIG. 7B). The ends of the tension bars 44-1 are connected to the brackets 90 at pivot arm 42. The other end of the tension bars 44-1 are connected to the brackets 90 on the pivot arm 40-1 (see FIG. 7A). The linkage of the tension bars 44-1 through 44-5 create a state of tension between all of the tension bars that would cause the pivot arms to rotate about their respective pivot axes when the motor moves its motor linear drive arm 126.

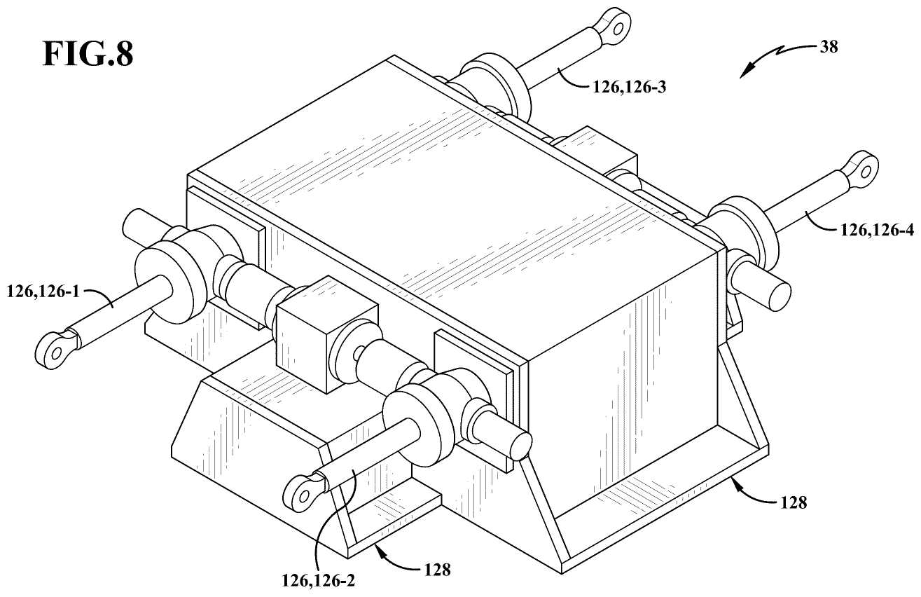

FIG. 8 depicts that the motor 38 has four motor linear drive arms, namely first motor linear drive arm 126-1, a second motor linear drive arm 126-2, a third motor linear drive arm 126-3 and a fourth motor linear drive arm 126-4. The four motor linear drive arms move in the longitudinal direction X in unison.

The motor 38 may include a base frame 128. The base frame 128 is configured to sit within a well 130 formed in the ground or floor 132. Typically, the ground 132 will be the concrete floor of a factory.

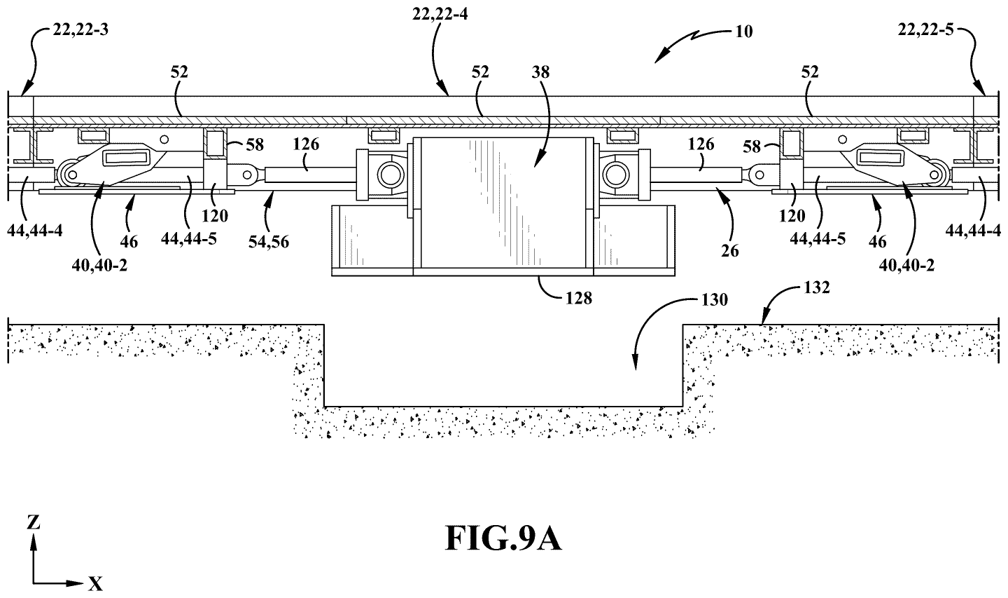

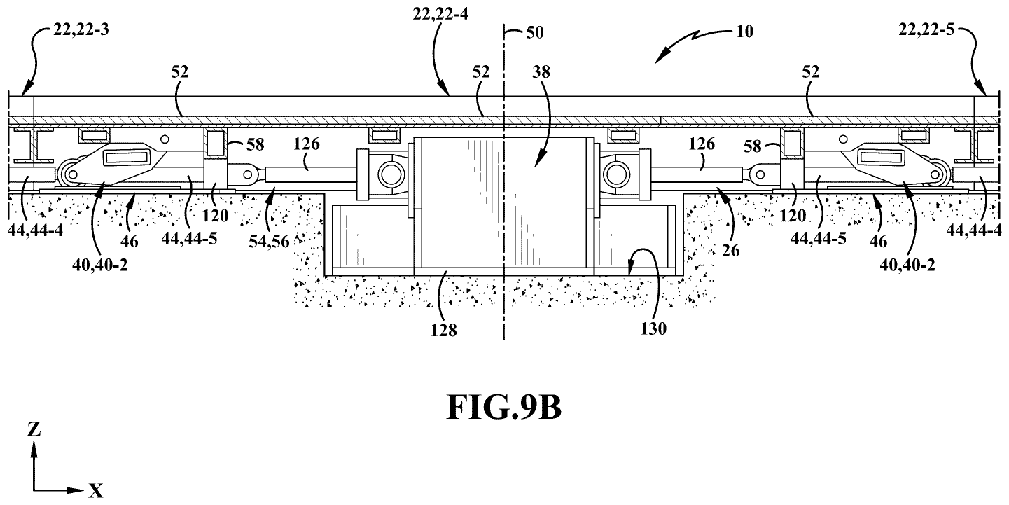

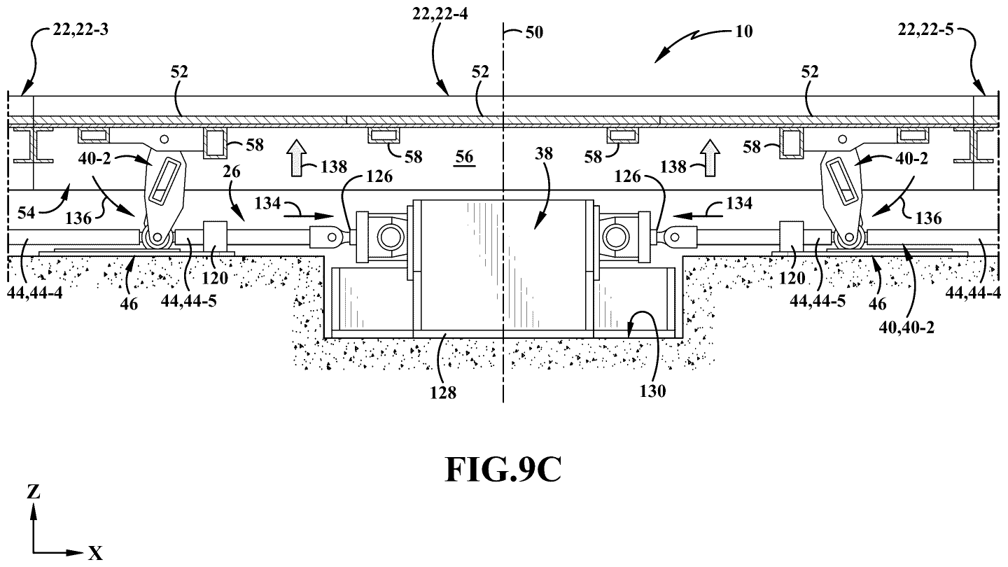

As depicted in FIG. 9A and FIG. 9B, the depth of the well 130 should be sufficient to accommodate the base 128 of the motor 38 such that the base 128 sits within the well and positions the motor linear drive arm 126 slightly above the ground surface 132.

FIG. 9C depicts the operation of the stand assembly 10. More particularly, FIG. 9C depicts the operation of the stand assembly moving from the lowered position to the raised position. In order to raise the platform, a control signal is sent from an electronic control unit (ECU) or other stand assembly control logic to the motor 38 to retract the motor linear drive arms 126 as indicated by arrows 134. The movement of the motor linear drive arm 126 inwardly towards the transverse axis 50, as indicated by arrows 134, causes the tension rods 44 to pull towards the transverse axis 50. The pulling of the tension rods 44 toward the transverse axis 50 causes the pivot arms to rotate about their respective pivot axes as indicated by arrows 136. The rotation of the pivot arms, namely all of the pivot arms 40 and pivot arms 42, as indicated by arrows 136, causes the wheels 86 to slide within their respective wheel channels 112 across the top of the lower frame plates, either the first lower frame plate 46 o the second lower frame plate 48, as the case may be. The rolling of the wheels 86 from a first position to a second position along the frame plates as a result of the pivoting action of the pivot arms causes the platform top surface 24 that is collectively defined by each platform segment 22-1 through 22-7 to raise upwardly in the vertical direction Z as indicated by arrows 138.

FIG. 10A and FIG. 10B diagrammatically depict the operation of the stand assembly 10. FIG. 10A depicts the stand assembly 10 in the lowered position. FIG. 10B depicts the stand assembly 10 in the raised position having lifted the platform 22 vertically upward in the vertical direction Z as indicated by arrows 138. Prior to the movement of the platform 22 relative to the vertical direction Z, the rods 44 are placed in a state of tension. In one particular embodiment, placing the rods 44 into a tensed state helps stabilize and support the platform 22. This further assist in creating the unitary movement of the platform surface 24 along the length of the platform 22. In one exemplary embodiment, when a tension rod 44 (already in a tensed state) is pulled by the motor to cause the pivot arms to rotate about one of the pivot axes 98, the tension in the rod 44 may remains constant due to the conservation of angular momentum. However, another embodiment of the lifting mechanism 26 could impart a varying tension through one or more rods 44 as the motor pulls the tension rods to rotate the pivot arms to lift the platform, as indicated by arrow 138.

Placing the tension rods 44 into a state of tension may be accomplished by pulling the rod or bar slightly and connecting it to one of the respective pivot flanges, which act as anchors that tense each respective rod 44. Alternatively, placing the tension rods 44 into a state of tension may be accomplished by rotating a turnbuckle or another object to apply tension along the length of a respective rod or bar. Regardless of how the rod 44 was put into a state of tension, the amount of tension that is to be applied may be set by a manufacturer's selected preference depending on the lifting needs and capabilities of the stand assembly 10.

As previously mentioned, in the particular embodiment, the tension rods are drawn inward towards the center axis 50 as indicated by arrows 134. The linear movement in the longitudinal direction indicated by arrow 134 imparted into the tension rods 44 causes each respective pivot arm to rotate thereby raising the platform up as the pivot arm pivots about its respective pivot axis as the wheels are drawn inwardly towards the transverse center axis 50.

Although this embodiment depicts that the tension rods are drawn inwardly to cause rotation of the pivot arms to thereby raise the platform, it is to be understood that the structural arrangement could be reversed such that the tension rods are extended outwardly from the motor 38 in a linear direction to raise the platform 22. As such, the present disclosure is intended to embody any linear movement of the tension rods to cause the pivot arms to rotate to raise the platform, regardless of whether the rods 44 are drawn inward toward the motor 38 or extended away from the motor 38.

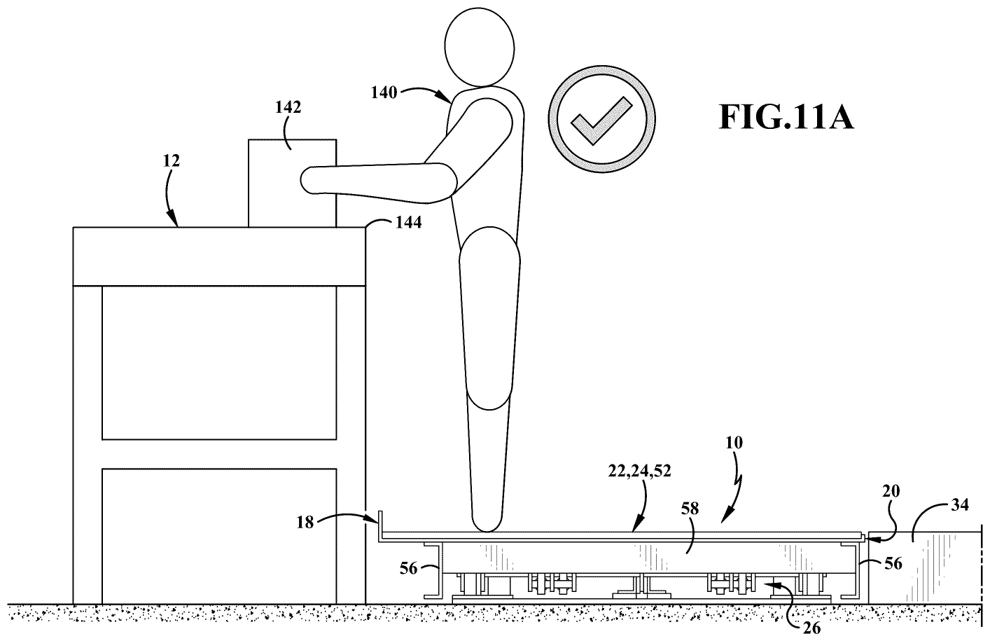

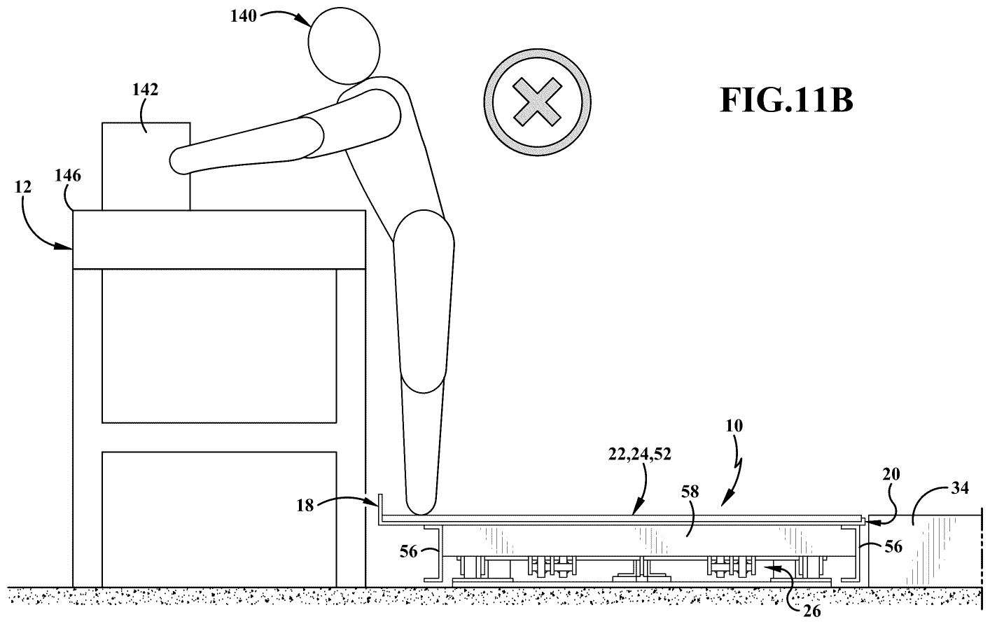

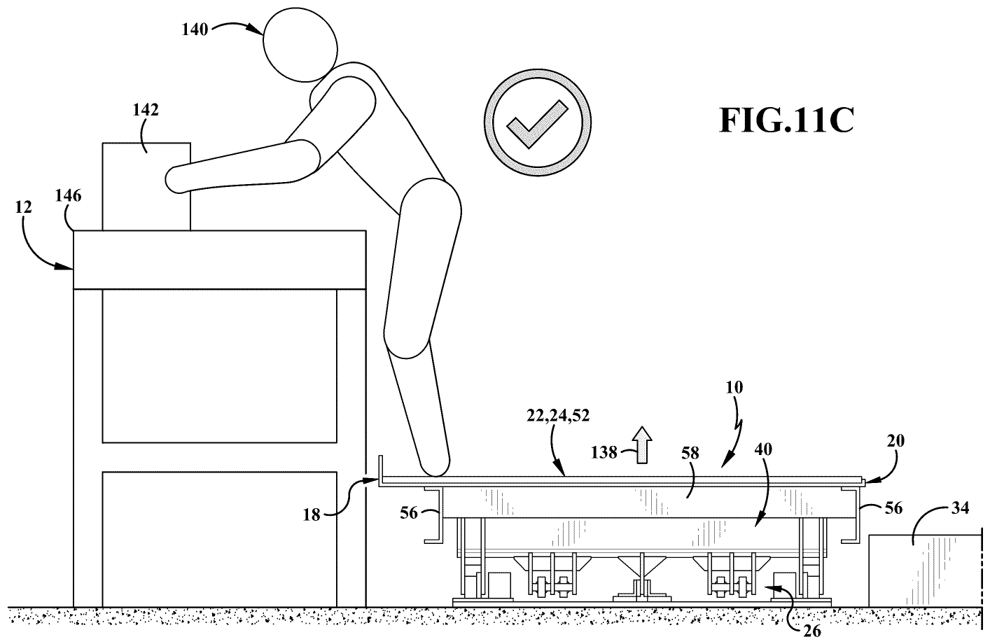

FIG. 11A-FIG. 11C depict the interaction of a worker 140 that is standing upon the stand assembly 10. Particularly, FIG. 11A depicts a scenario in which an item 142 moving along the conveyor assembly is located near a proximal edge 144 of the conveyor assembly 12 (e.g., the edge of the conveyor that is closer to the worker). When an item 142 is located near the proximal edge 144 the stand assembly 10 will be in its lowered position as indicated in FIG. 11A. This stand assembly 10 creates an ergonomic platform for the worker 140 to lift or remove the item 142 from the conveyor assembly 12. There is a symbolic check mark shown in FIG. 11A that indicates this is a proper ergonomic position.

FIG. 11B depicts a scenario that is a non-ergonomical way of removing the item 142 from the conveyor assembly 12. Particularly, it is not ergonomical to remove the item 142 when the item 142 is located near a distal edge 146 of the conveyor assembly and the stand assembly 10 is in its lowered position. There is an X-mark shown in FIG. 11B that indicates this is an improper ergonomic position.

FIG. 11C depicts another proper ergonomic alignment and purpose for the stand assembly 10. Namely, if the item 142 is located near the distal edge 146 of the conveyor assembly 12, then the stand assembly 10 can be raised to the raised position as indicated by arrow 138 and shown in FIG. 11C. This will raise the worker 140 to the elevated height to make it easier for the worker 140 to reach across the conveyor assembly 12 in order to grasp item 142. The worker can then more ergonomically remove the item 142 from the conveyor assembly 12 where it can then be moved onto various storage racks or stands 34 that are positioned behind the worker 140 near the second side 20 of the lift stand assembly 10. There is a symbolic check mark shown in FIG. 11C that indicates this is a proper ergonomic position.

The preceding paragraphs exemplified that wherein the platform is moved to a selected height based on a location of the part or item 142 that is to be retrieved from a path of travel along the conveyor assembly. However, another embodiment of the present disclosure provides that the platform 22 is moved to a selected height based on a feature of the part that is to be retrieved from a path of travel along the conveyor assembly. For example, the feature could be the size of the part or item 142, the shape of the part or item 142, or the weight of the part or item 142. For example, for a larger sized part or item 142, the platform 22 could be raised or lowered, in the manner described herein, to ergonomically position the worker at a height that increases ergonomic efficiency for lifting a larger sized part or item 142. In another example, the platform 22 could be raised or lowered, in the manner described herein, to ergonomically position the worker at a height that increases ergonomic efficiency for lifting an oddly-shaped or asymmetrically-shaped part or item 142. In yet another example, the platform 22 could be raised or lowered, in the manner described herein, to ergonomically position the worker at a height that increases ergonomic efficiency for lifting a heavier part or item 142.

The time at which the platform 22 may be pre-set by the manufacturer prior to moving parts or items 142 along the conveyor assembly 12. For example, assume that on a first day of manufacturing production that small items 142 are conveyed near a distal edge of the conveyor assembly 12. Prior to conveyance on the first day, the manufacturer may set the height of the platform 22 to an elevated or raised position in anticipation of that day's production run of items moving along conveyor assembly 12 near the distal edge. Then, assume that on a subsequent second day of manufacturing production that small items are conveyed near a proximal edge of the conveyor assembly 12. Prior to conveyance of items 142 on the second day, the manufacturer may set the height of the platform 22 to a lowered position in anticipation of that day's production run of items 142 moving along conveyor assembly 12 near the proximal edge. Then, assume that on a subsequent third day of manufacturing production that large items 142 are conveyed near the center of the conveyor assembly 12. Prior to conveyance of items 142 on the third day, the manufacturer may set the height of the platform 22 to a middle position (e.g., somewhere between the lowered position and the raised position) in anticipation of that day's production run of items 142 moving along conveyor assembly 12 near the center. Then, assume that on a subsequent fourth day of manufacturing production that oddly-shaped or asymmetrical items 142 are conveyed near the distal edge of the conveyor assembly 12. Prior to conveyance of items 142 on the fourth day, the manufacturer may set the height of the platform 22 to the raised position in anticipation of that day's production run of items 142 moving along conveyor assembly 12 near the distal edge. These assumptions and examples are merely exemplary and meant to convey to reader that the platform assembly 10 is infinitely adjustable and variable within its bounded limits depending on the part (i.e., either the part or item's location or feature) moving along the conveyor assembly 12.

The position of the platform can be based on instructions provided to the ECU or other control unit on the assembly 10. The instructions may be embodied as a computer program product that executes computer-implemented software code or instructions via a processor to implement the movement of the platform 22. Further, the computer-implemented software code or instructions to move the platform 22 may also account for manufacturer supplied pick-up directives for the worker as to how to lift the item 142 conveyed along the conveyor assembly 12. For example, the worker may be provided with a directive or order as to how to lift the item 142 based on its size, weight and/or shape. For example, the worker may be directed to lift the item 142 with one hand near the base of the item 142 and another hand near the top of the item 142. These pick-up directives may be accounted for by the ECU or control unit and use these pick-up directives as an input variable that is considered when determining at what height the platform 22 should be position for that day's manufacturing production run of items 142.

Although the assembly 10 has been exemplified with respect to a conveyor assembly with a conveyor belt or rollers in an automobile factory moving automobile parts along a conveyor belt, it should be understood that the ergonomic challenges outlined in the scenario of retrieving parts from a conveyor belt are prevalent across various manufacturing industries, not just limited to automobile factories. In any manufacturing setting where personnel are tasked with retrieving components from conveyor systems, issues related to ergonomics can arise. For instance, workers may encounter difficulties when reaching over to extract parts from the far edge of the conveyor belt, potentially leading to strains or injuries, particularly in the back and upper body regions. Similarly, lifting parts into high bins or racks can impose significant stress on the worker's back, especially if the lifting motion requires extending the arms overhead. These ergonomic concerns are universal and demand attention to ensure the safety and well-being of workers across diverse manufacturing environments. As such, it is to be understood that assembly 10 can be used in any type of manufacturing environment, regardless of the resultant device being manufactured.

The assembly 10 of the present disclosure may additionally include one or more sensors to sense or gather data pertaining to the surrounding environment or operation of the assembly 10. Some exemplary sensors capable of being electronically coupled with the assembly 10 of the present disclosure (either directly connected to the assembly 10 of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; global positioning sensors sensing location, elevation, distance traveled, velocity/speed; audio sensors sensing local environmental sound levels, or voice detection; photo/light sensors sensing ambient light intensity, ambient, day/night, UV exposure; TV/IR sensors sensing light wavelength; temperature sensors sensing machine or motor temperature, ambient air temperature, and environmental temperature; radar sensors; lidar sensors; ultrasonic sensors; magnetic sensors, image sensors; and moisture sensors sensing surrounding moisture levels.

If sensors are utilized to gather data relating to the assembly 10 of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the assembly 10 of the present disclosure. In one embodiment, the assembly 10 of the present disclosure can be used to teach a sensor model to predict sensor data for a specific scenario. Alternatively, sensor models can be utilized to generate the data to train the AI. The sensor model can be trained for any type of sensor, such as those types of sensors described above, and/or other sensor types. The elements described herein may be implemented as discrete or distributed components in any suitable combination and location. The various functions described herein may be conducted by hardware, firmware, and/or software. For example, a processor may perform various functions by executing instructions stored in memory.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a scene as input using any number of data structures and/or channels (e.g., concatenated vectors, matrices, tensors, images, etc.).

In a particular embodiment, the assembly 10 of the present disclosure can use the sensors to acquire a representation of the real-world environment (e.g., a physical environment) at a given point in time. Data from these sensors may be used to generate a representation of a scene or scenario, which may then be used to teach a sensor model. For example, a representation of a scene can be derived from sensor data, properties of objects in the scene or surrounding environment such as positions or dimensions (e.g., depth maps), classification data identifying objects in the scene or surrounding environment, properties or classification data of components of the assembly 10 of the present disclosure, or some combination thereof. Generally, the sensor model learns to predict sensor data from a representation of the scene, environment or operation of the assembly 10 of the present disclosure.

The sensor model architecture can be selected to fit the shape of the desired input and output data. Examples of architectures (e.g., DNNs) include, but are not limited to, perceptron, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a convolutional neural network (CNN) that accepts and evaluates an input image and may include multiple input channels, which may be used to accept and evaluate multiple input images and/or input vectors.

In one embodiment, training data for the sensor model may be generated using real-world (e.g., physical environment) data. To collect real-world training data, the assembly 10 of the present disclosure may collect sensor data by fusing sensors as the vehicle traverses a real-world environment. The sensors of the assembly 10 of the present disclosure may include, for example, one or more global navigation satellite systems sensors (e.g., Global Positioning System sensors (GPS)), RADAR sensors, ultrasonic sensors, LIDAR sensors, inertial measurement unit (IMU) sensors (e.g., accelerometer(s), gyroscope(s), magnetic compass(es), magnetometer(s), etc.), ego-motion sensors, microphones, stereo cameras, wide-view cameras (e.g., fisheye cameras), infrared cameras, surround cameras (e.g., 360 degree cameras), long-range and/or mid-range cameras, speed sensors (e.g., for measuring the speed of the vehicle), vibration sensors, steering sensors, brake sensors (e.g., as part of the brake sensor system), and/or other sensor types.

In another embodiment, training data for the sensor model is generated based on simulated or virtual environments. The training data may then be used to train the sensor model for use in real-world autonomous applications, e.g., to control the operation of the assembly 10 of the present disclosure. The training data may be derived to fit the shape of the input and output data for the sensor model, which may depend on the architecture of the sensor model. For example, sensor data may be used to encode an input scene, input parameters, and/or ground truth sensor data using different data structures and/or channels (e.g., concatenated vectors, matrices, tensors, images, etc.).

The assembly 10 of the present disclosure may include hardware, software and/or firmware responsible for managing the sensor data generated by the sensors. The autonomous hardware, software, and/or firmware being executed may manage different environments using one or more maps (e.g., 3D maps), positioning component(s), and the like. The autonomous hardware, software, and/or firmware may also include components to plan, control, and generally manage the assembly 10 of the present disclosure. In one example, the autonomous hardware, software, and/or firmware can be installed in and used to control the assembly 10 of the present disclosure through the environment based on the sensor data, one or more machine learning models (e.g., neural networks), and the like. A training system may use the training data to train the sensor model to predict virtual sensor data for a given scene, environment, or operation of a component.

The training system can include one or more servers (e.g., a graphics processing unit server) and data stores and may use a cloud-based deep learning infrastructure with artificial intelligence to analyze the sensor data received from the assembly 10 of the present disclosure and/or stored in the data store. The training system can also incorporate or train up-to-date, real-time neural networks (and/or other machine learning models) for one or more sensor models.

The assembly 10 of the present disclosure may include wireless communication logic coupled to sensors on the assembly 10. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®), ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the assembly 10 of the present disclosure may serve as a repeater, or the devices, assemblies, or systems of the present disclosure may be connected together in a mesh network to relay signals from one assembly 10 to the next. However, the individual assembly 10 in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the assembly 10 of the present disclosure may differ from embodiment to embodiment. In one embodiment, alerts and signals from the assembly 10 of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular assembly 10 of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the assembly 10 of the present disclosure may also be sent to a work tracking system that allows the individual, or the organization for which he or she works, to track the status of the various alerts that are received, to schedule particular workers to repair a particular assembly 10 of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the assembly 10 of the present disclosure, and the system may be able to provide aggregate machine operational data for an assembly 10 of the present disclosure or group of devices, assemblies, or systems of the present disclosure.

The system also allows individuals to access the assembly 10 of the present disclosure for configuration and diagnostic purposes. In that case, the individual processors or microcontrollers of the assembly 10 of the present disclosure may be configured to act as Web servers that use a protocol like hypertext transfer protocol (HTTP) to provide an online interface that can be used to configure the assembly 10. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the a component, element, or feature of assembly 10 being shaped as described, that component, element, or feature can be semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A personnel stand assembly comprising:
a platform extending from a first end to a second end defining a longitudinal direction therebetween, the platform having a first side and a second side defining a transverse direction therebetween, and the platform having a top surface and a lower surface defining a vertical direction therebetween, wherein the top surface is adapted to support a worker standing thereon and the platform is adapted to be installed adjacent a conveyor assembly with items moving along the conveyor assembly;
a lowered position of the platform and a raised position of the platform, wherein the platform moves between the lowered position and the raised position; and
wherein the platform is moved to a selected height based on an item that is to be retrieved from a path of travel along the conveyor assembly.

2. The personnel stand assembly of claim 1, wherein the platform is moved to a selected height based on a feature of the item that is to be retrieved form the path of travel along the conveyor assembly.

3. The personnel stand assembly of claim 1, wherein the platform is moved to a selected height based on a location of the item that is to be retrieved from the path of travel along the conveyor assembly.

4. The personnel stand assembly of claim 1, wherein movement of the platform occurs in response to the location of the item that is to be retrieved from the conveyor assembly, wherein items that are located on the conveyor assembly distally from the platform cause the platform to move toward the raised position and items on the conveyor assembly located proximal to the platform cause the platform to move toward the lowered position.

5. The personnel stand assembly of claim 1, further comprising:
a lifting mechanism positioned beneath the lower surface of the platform, wherein each end of the platform raises and lowers in unison in response to movement of the lifting mechanism.

6. The personnel stand assembly of claim 5, wherein the lifting mechanism includes:
a pivot arm having a first end and a second end defining a length of the pivot arm therebetween, wherein the length of the pivot arm is oriented in the transverse direction beneath the lower surface of the platform.

7. The personnel stand assembly of claim 6, wherein the pivot arm further comprises:
a top and a bottom;
a first pivot connection located on the top of the first end of the pivot arm, wherein a pivot axis extends through the first pivot connection, wherein the pivot axis is aligned in the transverse direction; and
a second pivot connection located on the top of the second end of the pivot arm, wherein the pivot axis extends through the second pivot connection.

8. The personnel stand assembly of claim 7, wherein the pivot arm further comprises:
a main body of the pivot arm that is positioned below the pivot axis;
a first pair of flanges at the first end of the main body, wherein the first pivot connection is defined between the first pair of flanges; and
a second pair of flanges at the second end of the main body, wherein the second pivot connection is defined between the second pair of flanges.

9. The personnel stand assembly of claim 6, wherein the pivot arm further comprises:
a top and a bottom;
a first wheel located on the bottom near the first end of the pivot arm; and
a second wheel located on the bottom near the second end of the pivot arm.

10. The personnel stand assembly of claim 5, wherein the lifting mechanism further comprises:
a first pivot arm below the platform;
a second pivot arm below the platform; and
at least one tension bar that has a first end connected to the first pivot arm and a second end connected to the second pivot arm, wherein the at least one tension bar is in a state of tension during operation of the lifting mechanism to move the platform between the lowered position and the raised position.

11. The personnel stand assembly of claim 10, wherein the state of tension in the at least one tension bar varies by less than 5% during movement of the platform between the lowered position and the raised position.

12. The personnel stand assembly of claim 10, wherein the state of tension in the at least one tension bar is constant.

13. The personnel stand assembly of claim 10, wherein linear translation of the at least tension bar in the longitudinal direction imparts rotational movement to the first pivot arm and the second pivot arm.

14. The personnel stand assembly of claim 1, further comprising:
a control unit that executes instructions stored in at least one non-transitory computer readable storage medium, wherein the instructions include an instruction to automatically raise or lower the platform based on the item that is to be retrieved form a path of travel along the conveyor assembly.

15. A method comprising:
having a personnel stand assembly installed adjacent to a conveyor assembly, wherein the personnel stand assembly comprises a platform extending from a first end to a second end defining a longitudinal direction therebetween, the platform having a first side and a second side defining a transverse direction therebetween, and the platform having a top surface and a lower surface defining a vertical direction therebetween;
moving the platform between a lowered position and a raised position of the platform, wherein the platform is moved to a selected height based on an item that is to be retrieved from a path of travel along the conveyor assembly; and
effecting a worker to stand upon the platform at the selected height and retrieve the item from the conveyor assembly.

16. The method of claim 15, wherein the selected height of the platform is based on a location of the item on the conveyor assembly.

17. The method of claim 16, further comprising:
raising the platform upward in response to the item being located near a distal edge of the conveyor assembly.

18. The method of claim 16, further comprising:
lowering the platform downward in response to the item being located near a proximal edge of the conveyor assembly.

19. The method of claim 15, wherein moving the platform between a lowered position and a raised position of the platform is accomplished by a lifting mechanism positioned beneath the lower surface of the platform, and the lifting mechanism comprises at least one pivot arm in operation communication with a tension bar that is coupled to a motor that linearly translates the tension bar.

20. The method of claim 19, wherein each end of the platform raises and lowers in unison in response to movement of the lifting mechanism.
